(19) United States
(12) Patent Application Publication
(10) Pub. No.: US 2005/0051058 A1
(43) Pub. Date: Mar. 10, 2005

(54) Chemical admixture for cementitious compositions

(76) Inventor: Semyon A. Shimanovich, Brooklyn, NY (US)

Correspondence Address: FISH & NEAVE IP GROUP;ROPES & GRAY LLP, 1251 AVENUE OF THE AMERICAS, 50TH FLOOR, NEW YORK, NY, 10020-1105, US

(21) Appl. No.: 10/877,314

(22) Filed: Jun. 24, 2004

Related U.S. Application Data
(60) Provisional application No. 60/482,304, filed on Jun. 24, 2003.

(51) Int. Cl. C04B 7/32

(52) U.S. Cl. 106/692; 106/819; 106/823; 106/695; 106/809

(57) ABSTRACT

A non-chloride powder admixture that, when added to concrete, substantially reduces the setting time for concrete and increases the strength of the concrete is provided. The powder admixture preferably comprises a calcium aluminate compound (e.g., SECAR 51) and a lithium carbonate compound. The calcium aluminate compound preferably has at least 51.7% alumina. In some embodiments, a surfactant may be added to the mixture of the calcium aluminate compound and the lithium carbonate compound. In some embodiments, the powder admixture may be blended with a cementitious material, such as fly ash or slag. Upon adding water to the admixture and cementitious material mixture, both the setting time of the mixture reduces and the strength of the mixture increases as compared to the setting time and strength of the cementitious material without the powder admixture.

### CROSS-REFERENCE TO RELATED APPLICATION

This application claims the benefit of Shimanovich U.S. Provisional Patent Application No. 60/482,304, filed Jun. 24, 2003, which is hereby incorporated by reference in its entirety.

### BACKGROUND OF THE INVENTION

The present invention relates to a cement additive. More particularly, the invention relates to a non-chloride powder admixture that, when added to concrete, substantially reduces the setting time for concrete and increases the strength of the concrete.

Concrete generally has four components: a cement, a course aggregate of one or more rocks or minerals (e.g., granite, basalt, sandstone, etc.), a fine aggregate of sand, and water. Upon adding water to the cement and aggregate mixture, an exothermic reaction is induced which, after time, hardens the concrete. It is desirable to use concrete because it is the only major building material that can be delivered to a job site in a soft state. This unique quality makes concrete a desirable building material because it can be molded to virtually any form or shape.

The setting times for commercially available cements vary fairly widely, but are typically on the order of about three hours. However, it should be noted that the setting times for cements are dependent upon the amount of cement being used. It would be advantageous to substantially reduce the setting time for cement, for example, in the construction of concrete buildings and patchwork applications for repairing concrete roadways. Furthermore, there are other materials, such as granite and marble, which are more durable and stronger than cement.

An admixture is a material that is used as an ingredient of concrete and is added to the concrete immediately before or during its mixing. Admixtures are used to modify the properties of the concrete in such a way as to make it more suitable for a particular purpose. That is, admixtures are used to achieve certain properties in concrete more effectively than by other means, to maintain the quality of concrete through the successive stages of mixing, transporting, placing, and curing during adverse conditions, and to reduce the cost of concrete construction. Using an admixture may allow the employment of less expensive construction methods or designs, thereby more than offsetting the costs of the admixture.

Admixtures are commercially available as ready-to-use liquids added at, for example, a bulk blending station. However, powder admixtures that substantially reduce the setting time for concrete and increase the strength of the concrete are not readily available.

It would therefore be desirable to provide a non-chloride powder admixture that, when added to concrete, substantially reduces the setting time for concrete and increases the strength of the concrete.

### SUMMARY OF THE INVENTION

It is therefore an object of this invention to provide a non-chloride powder admixture and a method for making the same that, when added to concrete, substantially reduces the setting time for concrete and increases the strength of the concrete over a predetermined setting time.

In accordance with this invention, a non-chloride powder admixture is provided. To create the powder admixture, a calcium aluminate compound (e.g., SECAR 51, which is manufactured by Lafarge Calcium Aluminates, Inc.) and a lithium carbonate compound are combined in a mixer and blended for about five to twenty minutes. It should be noted that the mixing time may depend, for example, on the amount of material being blended. The calcium aluminate compound preferably has at least 51.7% alumina. Note that the setting time for concrete with an admixture having a high percentage of alumina will be significantly shorter than the setting time for concrete with an admixture having a small percentage of alumina in the same period of time and with the same amount of concrete.

In some embodiments, a surfactant may be added to the mixture of the calcium aluminate compound and the lithium carbonate compound. Preferably, the surfactant is added in a dosage of between about 1% to about 3% of the total weight of the chemical admixture. Examples of surfactants include naphthalene sulfonate-formaldehyde condensate, LOMAR D (a sodium salt of sulfonated naphthaleneformaldehyde condensate manufactured by the Henkel Corporation), TAMOL (a sodium salt of naphthalenesulphonic acid condensation products manufactured by Rohm and Haas Company), or any other suitable surfactant for use with cementitious materials.

In some embodiments, the admixture may be blended with a cementitious material, such as fly ash or slag. Preferably, the percentage of the chemical admixture to the cementitious material is between about 1% to about 15% by weight. It should be noted that adding the chemical admixture to the cementitious material such that the percentage of the chemical admixture to the cementitious material is between about 1% to about 30% by weight will decrease the setting time of the cementitious material. When the percentage is greater than about 33%, the cementitious material will have no workability.

Upon adding water to the admixture and cementitious material mixture, both the setting time of the mixture substantially reduces and the strength of the mixture increases as compared to the setting time and strength of the cementitious material without the powder admixture.

### BRIEF DESCRIPTION OF THE DRAWINGS

Further features of the present invention, its nature, and various advantages will be more apparent from the following detailed description of the preferred embodiments, taken in conjunction with the accompanying drawing, in which like reference characters refer to like parts throughout, and in which:

FIG. 1 shows a graph illustrating the influence of the lithium carbonate compound on the strength of a cementitious material over time.

### DETAILED DESCRIPTION OF THE INVENTION

In accordance with this invention, a powder admixture that both substantially reduces the setting time of concrete and increases the strength of the concrete is provided.

The powder admixture comprises at least three components: a calcium aluminate compound, such as SECAR 51, a lithium carbonate compound, and a surfactant.

The calcium aluminate compound, such as SECAR 51, is a hydraulic binder that preferably has an alumina content of about 51.7%. It should be noted that an admixture having any percentage of alumina will decrease the setting time of the concrete. However, the setting time for concrete with an admixture having a high percentage of alumina will be significantly shorter than the setting time for concrete with an admixture having a small percentage of alumina in the same period of time and with the same amount of concrete. Composed mainly of calcium aluminate, SECAR 51 is used for refractory and construction applications. The preferable composition of the calcium aluminate compound is as follows:

| | |
|---|---|
| Al₂O₃ | 51.7% |
| CaO | 39.2% |
| SiO₂ | 4.3% |
| Fe₂O₃ | 1.5% |
| TiO₂ | 3.3% |

The powder admixture having the calcium aluminate compound may be used for substantially reducing the setting time of the concrete, for example, from 187 minutes without the powder admixture, to as little as 6 minutes with the admixture. As shown in Table 1, depending on the quantity of the chemical admixture, which includes the calcium aluminate compound, used in the cement, the setting time of the cement may be reduced by up to a factor of 31 times. The following table illustrates the influence of different percentages of the chemical admixture on the setting time of Portland Cement.

TABLE 1
Influence of the Chemical Admixture on the
Time of Setting Hydraulic Cement Mortar with
Allentown Portland Cement Type I (ASTM C807-
89, Vol. 04-01).

| | | | | | | | | |
|---|---|---|---|---|---|---|---|---|
| Quantity of | 0 | 2.5 | 5 | 10 | 15 | 20 | 25 | 33 |
| Admixture | (Ref.) | | | | | | | |
| (% in cement | | | | | | | | |
| by weight) | | | | | | | | |
| Time of | 187 | 119 | 68 | 24 | 14 | 11 | 7 | 6 |
| setting | | | | | | | | |
| (minutes) | | | | | | | | |
| Acceleration | 1 | 1.6 | 2.75 | 8 | 13 | 17 | 27 | 31 |
| factor | | | | | | | | |

The preferable composition of the lithium carbonate compound is as follows:

| | |
|---|---|
| Li₂CO₃ | 99.6% |
| H₂O | 0.34% |
| CI | 0.005% |
| SO₄ | 0.04% |
| Fe₂O₃ | 0.0001% |
| CaO | 0.009% |
| Na₂O | 0.03% |
| Insolubles | 0.002% |

The lithium carbonate compound may be used to increase the strength of the concrete. For example, concrete typically has a strength of about 2,000 psi after setting for 24 hours. Upon adding the admixture to the concrete, the strength of the concrete can increase up to about 7,000 psi in the same period using the admixture having 3% by weight of the calcium aluminate compound and the lithium carbonate compound. Table 2 shows the influence of the chemical admixture that includes the lithium carbonate compound on the strength of the cement over a period of time.

TABLE 2
Influence of the Chemical Admixture that
includes the Lithium Carbonate Compound on
the Strength of Cement Compositions (Content
3% of admixture Secar 51, time of setting -
225 minutes)

| | Compressive Strength, psi | | | | | | |
|---|---|---|---|---|---|---|---|
| Age | Sample Numbers | | | | | | |
| (hours) | 157 | 158 | 159 | 163 | 164 | 165 | 170 |
| 3.75 | 5.6 | 10.3 | 120.4 | 101.8 | 48.5 | 234.1 | 29.3 |
| 4 | 5.6 | 12.7 | 126.4 | 108.3 | 58 | 242.6 | 40.4 |
| 4.75 | 12.4 | 24.1 | 274.2 | 191.6 | 108.6 | 363.5 | 217.6 |
| 8 | 113.7 | 173.8 | 773.5 | 897.4 | 571.8 | 1154.2 | 985.7 |
| 12 | 572.7 | 652.5 | 1657.8 | 2026.8 | 1398.1 | 2042 | 1997.4 |
| 24 | 2267.2 | 2137.3 | 3478 | 3510 | 2681.2 | 3598.4 | 2179.6 |

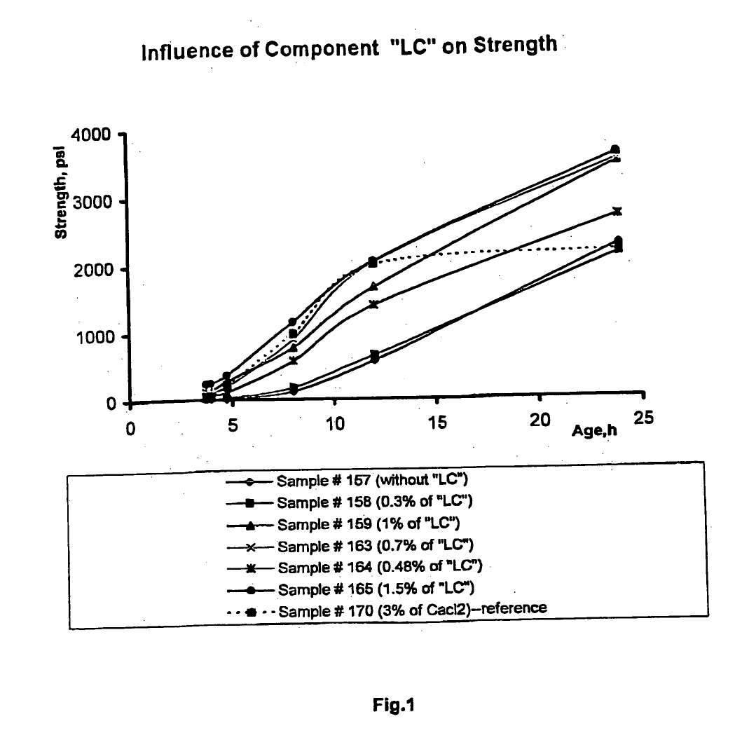

FIG. 1 also shows the influence of the chemical admixture that includes the lithium carbonate compound on the strength of cement over a period of time. Both Table 2 and FIG. 1 show that as the amount of the lithium carbonate compound in the admixture is increased, the strength of the concrete increases over time.

The amount of the lithium carbonate compound added to the calcium aluminate compound preferably varies from about 0.01% to about 1.5% by weight of the cement, including the calcium aluminate compound. For example, if the amount of the calcium aluminate compound replaces 100% of the cement, with a 0.01% dosage of a lithium carbonate compound, concrete that would ordinarily have a strength of about 2,000 psi in 24 hours preferably reaches a strength of about 7,000 psi in the same period of time.

A surfactant may be added to the mixture of the calcium aluminate compound and the lithium carbonate compound to improve the flowability of the cement while reducing the ratio of water to cement. Preferably, the surfactant is added in a dosage of between about 1% to about 3% of the total weight of the chemical admixture. In some embodiments, the surfactant is a water reducing admixture. Examples of surfactants include naphthalene sulfonate-formaldehyde condensate, LOMAR D, TAMOL, or any other suitable surfactant.

To create such an admixture, the calcium aluminate compound (SECAR 51) and the lithium carbonate compound having the above-mentioned compositions are combined in a mixer and blended for about five to twenty minutes. It should be noted that the mixing time may depend, for example, on the amount of material being blended. The surfactant may also be added into the mixture and mixed until it is dispersed through the mixture.

In some embodiments, the admixture may be blended with a cementitious material, such as fly ash or slag cement. Preferably, the ratio of the chemical admixture to the cementitious material is between about 1% to about 15%. However, it should be noted that when the ratio is greater than about 33%, the mixture of the cementitious material and the chemical admixture may not be workable.

These cementitious materials are often by-products of other processes or natural materials. For example, fly ash is a silica and alumina residue collected from the chimneys of power generators (e.g., coal-fired power plants and incinerators). Slag cement, which is also known as ground granulated blast-furnace slag, is a material resulting from the reduction of iron ore into iron. Iron ore, limestone/dolomite flux material, and fuel are charged into an iron blast furnace. Molten slag is separated from the molten iron, and rapidly quenched with water or air at a granulator. The resulting granules are dried and ground to a fine powder to make slag cement. It should be noted that slag cement is generally a more uniform material than fly ash. As a result, concrete made with slag cement will generally have more uniform properties than concrete made with fly ash.

After adding water to the mixture having the non-chloride powder admixture and the cementitious material (e.g., slag or fly ash), it creates a concrete having a substantially reduced setting time and increased strength. For example, when slag and the powder admixture are mixed with water, a strong, fast-setting concrete that can replace other materials, such as Portland cement, is created.

Thus, a non-chloride powder admixture that, when added to concrete, substantially reduces the setting time for concrete and increases the strength of the concrete is provided. Persons skilled in the art will appreciate that the present invention can be practiced by other than the described embodiments, which are presented for purposes of illustration and not of limitation, and that the present invention is limited only by the claims which follow.

1. An admixture for cementitious compositions comprising:
a calcium aluminate compound;
a lithium carbonate compound; and
a surfactant.

2. The admixture of claim 1 wherein the calcium aluminate compound has at least 51.7% alumina.

3. The admixture of claim 1 wherein the calcium aluminate compound is SECAR 51.

4. The admixture of claim 1 wherein the surfactant is LOMAR D.

5. The admixture of claim 1 wherein the surfactant is TAMOL.

6. The admixture of claim 1 wherein the surfactant is a water reducing admixture.

7. The admixture of claim 1 wherein the surfactant is napthalene sulfonate-formaldehyde condensate.

8. The admixture of claim 1 wherein the surfactant is added in a dosage of between about 1% to about 3% by weight of the admixture.

9. A powder admixture that substantially reduces the setting time for concrete and increases the strength of the concrete comprising:
a calcium aluminate compound
a lithium carbonate compound; and
a surfactant, wherein the surfactant is added in a dosage of between about 1% to about 3% of the total weight of the powder admixture.

10. The admixture of claim 9, wherein the calcium aluminate compound is SECAR 51.

11. A concrete compound mixable with water having a reduced setting time and increased strength comprising:
a cement of a given amount; and
a powder admixture, the admixture comprising:
a calcium aluminate compound, wherein the calcium aluminate compound has at least 51.7% alumina;
a lithium carbonate compound; and
a surfactant.

12. The composition of claim 11, wherein the calcium aluminate compound is SECAR 51.

13. The composition of claim 11, wherein the amount of lithium carbonate compound is between about 0.01% to 1.5% by weight of the given amount of cement.

14. The composition of claim 11, wherein the percentage of the powder admixture to the cement is between about 1% to about 30% by weight.

15. A cementitious composition comprising a cement, a calcium aluminate compound, a lithium carbonate compound, and a surfactant.

16. The cementitious composition of claim 15 wherein the calcium aluminate compound, the lithium carbonate compound, and the surfactant are added to the cement as an admixture.

17. The cementitious composition of claim 15 wherein the calcium aluminate compound is SECAR 51.

18. The cementitious composition of claim 15 wherein the amount of the lithium carbonate compound is in the range from about 0.01% to 1.5% by weight of the amount of the cement.

19. The cementitious composition of claim 15 wherein the cement is slag cement.

20. The cementitious composition of claim 15 wherein the cement is fly ash.

21. A method for creating a powder chemical admixture for use with a cementitious material using a mixer, comprising:
adding a calcium aluminate compound and a lithium carbonate compound into the mixer;
adding a surfactant into the mixer; and
mixing the calcium aluminate compound, the lithium carbonate compound, and the surfactant to form the powder chemical admixture.

22. The method of claim 21, wherein the calcium aluminate compound is SECAR 51.

23. The method of claim 21, wherein the amount of the lithium carbonate compound is between about 0.01% to 1.5% by weight of the amount of the cementitious material.

24. The method of claim 21, wherein the percentage of the powder admixture to the cementitious material is between about 1% to about 30% by weight.

25. A method for creating a cement compound material mixable with water using a mixer, comprising:
adding a calcium aluminate compound and a lithium carbonate compound into the mixer;
adding a surfactant into the mixer;
adding a cementitious material into the mixer;
mixing the calcium aluminate compound, the lithium carbonate compound, the surfactant, and the cementitious material to form the cement compound.

26. The method of claim 25, wherein the calcium aluminate compound is SECAR 51.

27. The method of claim 25, wherein the amount of the lithium carbonate compound is between about 0.01% to 1.5% by weight of the amount of the cementitious material.

28. The method of claim 25, wherein the percentage of the powder admixture to the cementitious material is between about 1% to about 30% by weight.
